(19) United States
(12) Patent Application Publication
(10) Pub. No.: US 2009/0150197 A1
(43) Pub. Date: Jun. 11, 2009

(54) System and method for managing the surety status reporting process

(76) Inventor: David V. Strauss, Houston, TX (US)

Correspondence Address: AKIN GUMP STRAUSS HAUER & FELD LLP, 1111 Louisiana Street, 44th Floor, Houston, TX, 77002, US

(21) Appl. No.: 12/001,221

(22) Filed: Dec. 11, 2007

(51) Int. Cl. G06Q 10/00

(52) U.S. Cl. 705/7

(57) ABSTRACT

A method is described for monitoring, documenting, analyzing, and reporting the status of a project being performed by a Principal for an Obligee. The monitoring, documenting, analyzing, and reporting is communicated to a Surety, which has given a Surety bond to the Obligee. In one embodiment, the method is performed using a computing device via a communications network, such as the Internet or an Intranet. The method allows the Surety to monitor the status of the project, compares the Principal's pay applications with the Obligee's reporting of the project's status, and requests site inspections, or the coordination thereof by the entity practicing the method. The method can also alert the Surety of change orders and any premiums due to the Surety based on any change orders as well as alert the Surety of project problems and changes in the expected projection completion.

### BACKGROUND OF THE INVENTION

The present invention relates to the contract Surety process and in facilitating, tracking, and maintaining communications between Obligees, Sureties, and Principals.

Principals are those entities having primary responsibility for an obligation. A Surety is an entity that has contracted to be responsible for the obligations of another, such as a Principal. Obligees are those entities to whom another (e.g. a Surety) is legally obligated (e.g. by way of a Surety bond) on behalf of a Principal. A Surety bond is a bond given to protect the recipient against loss in case the Principal does not perform the terms of a contract. In general the Principals are bonded entities, such as a contactor, subcontractor or vendor. The Obligees are beneficiaries of the bond, such as project owners, developers, and in some cases a contractor, when a Principal is a subcontractor. The Surety Bond is a guaranty instrument and is commonly referred to as a Payment and Performance Bond. Typically there are two bonds—one for payment and one for performance. For example, an Obligee could be the real-estate investment group that has contracted with a Principal (e.g. a building contractor) to construct a residential high-rise building. The Principal would take out a Surety bond with the Surety in order to guarantee its performance and to cover any losses incurred by the Obligee due to default (e.g., non-performance or mistake) by the Principal. The Principal pays the Surety a premium for the bond, which is the cost of the bond. In multi-million dollar projects, Obligee's require Principal to insure their performance. The Surety issues a bond for which a premium, typically a percentage of the contract amount is paid. Reinsurers often cover the backing for the bond. If changes are requested by the Obligee, this often times increases the cost of the project and the amount due to the Principal (i.e. the Premium due the Surety). As the cost of the project increases, so does the premium due the Surety.

All too often, Sureties are unaware of the status of a project for which they are responsible if the Principal defaults. A Surety's lack of knowledge about a project's status can lead to several negative consequences. For example, Sureties are often unaware of problems on a project until there is a default. Sureties are often unaware of their aggravated risk exposure, whether they are due a premium from the Obligee, and whether based on the action or inaction of the Obligee a defense to an Obligee's potential claim has been vitiated. In the contract Surety business, there is a need to provide an efficient and consistent process of tracking and documenting the status of a project.

### BRIEF SUMMARY OF THE INVENTION

The present invention is generally directed to a system and method for monitoring and documenting the status of projects being performed by a Principal (i.e. the bonded entity) for an Obligee for which a Surety Bond has been issued. In one aspect of the invention, the system reduces risk and liability for Sureties with respect to Surety Bonds. In one embodiment of the invention, a Status System uses a computer network and software program to monitor, track, and analyze the progress of projects by facilitating a communication network between the Principal, Obligee, and Surety. The Principal pays a Surety a premium for the Surety Bond and the Surety has the financial responsibility for guaranteeing to the Obligee the Principal's performance of the work project. Based on data about the Project, Principal, Obligee, and Surety Bond, a Status System creates a Project Profile. Based on the Project Profile, the Status System communicates via a computer network with the Obligee and/or Principal requesting periodic updates of the Project.

In one embodiment, there is a system for monitoring the status of a work project that is performed for the Obligee, with a Principal having the responsibility to perform the work project, and a Surety having the financial responsibility for guaranteeing to the Obligee the Principal's performance of the work project. The monitoring system includes communication between the Surety, Principal, and Obligee via a network, such as via the internet or a secure remote connection. Communication may be accomplished by using a computing device, such as a PDA, PC, desktop computer, thin client, or the like. In one aspect, either or any permutation of the Principal, Obligee, and Surety (or any single or combination of these entities) provide input data that provides the details of a work project, which comprises a Project Profile. The Project Profile generates a time table for sending request of a work project update from the Principal or Obligee, or both to the Surety or a Surety service provider. In another aspect the system generates expected results for the work project update request. The Status System determines if the work project update has been timely returned and if not it can generate a work project update follow-up routine. If the work project update has been timely returned the system compares the returned results to the expected results and generates an alert if the comparison detects a problem or unexpected result. In another aspect, the system compares the completed work project updates of the Principal and the Obligee to detect any problems or inconsistencies between the work project updates.

In one embodiment, the periodic update request requires the Principal and/or Obligee to give a detailed status update of the project, including communicating whether any change orders have been requested or completed, any pay applications have been submitted or received, or if any payments have been made or rejected. The update request could also require the Principal to submit its accounts payable as it relates to the work project that is the subject of the bond. In another embodiment, an application program is operating on the computer system of the Principal and/or Obligee, wherein the Principal and/or Obligee provides project updates to a database housed on the Surety's server or an agent or servicer acting on behalf of the Surety. In another aspect of an embodiment, the Status System reviews the project updates and determines if there are potential problems, such as delayed project completion, mismanagement of payments, undocumented change orders, costs overruns, and the potential default by the Principal. In another aspect, the Status System compares the project updates received from the Principal and Obligee to determine if there are inconsistencies or deviations between the project updates and if there are potential problems.

In another embodiment, the Status System, in addition to generating a Project Profile and project update requests, monitors the status of the status inquiry via the communication network and generates an alert if there is no response from the Obligee or Principal, or if there is a potential problem based on the status update received from the Principal and/or Obligee. In another embodiment, the Status System determines whether there is a premium due to the Surety based on the information in the Status System database, e.g. whether there has been a change order, or there is a potential for a change order.

In another embodiment, the Status System monitors, tracks, and documents the pay applications and payments made during the project, in order to determine if there are any project overruns or inconsistent payments considering the percentage of project completion. In another embodiment, when there are potential problems with a project triggered by the Status System, the Status System commands a site inspection by the Surety or a person or entity working on behalf of the Surety.

In another aspect of an embodiment of the invention, the data gathered on various Principals, Obligees, and other interested parties, from the operation of multiple Status System applications monitoring a variety of projects is compiled to provide a “clearing house” system for the Surety industry. In this aspect, Sureties or entities operating on their behalf using the Status System or via independent inquiry can determine the history of an Obligee and/or Principal, such as previous defaults, claims, claim related litigation, project overruns, number of current ongoing projects, etc. This linking of data provides Sureties with the information necessary to make a well-informed decision on any increase or decrease in premium the Surety assesses based on the previous performance of the Principal and/or Obligee.

Another aspect of an embodiment of the invention is that the status of the status inquiry is monitored through the network and any alerts or changes to the status of a project as well as any payments for the project are automatically generated and communicated to the Surety, e.g., by telephone, facsimile, mail, or electronic mail. In another embodiment, the Surety contracts with a Surety or Status System Service Provider, to have one or more of the functions, steps, and methods as described herein performed by a third-party service provider in the U.S. or abroad.

In another embodiment of the invention, the Status System is loaded with data and is programmed to alert the Surety or an entity working on the Surety's behalf that the Obligee may have waived the ability to make a claim against the bond. In one aspect of this embodiment, the failure of the Obligee to timely submit a status update when requested, or the prolonged notification of a project problem, may result in a waiver of a claim by the Obligee. Through its detailed documenting, tracking, and monitoring, the Status System provides the Surety with this invaluable information via reports and/or alerts associated with the Obligee and a project.

In another embodiment, the Status System provides Sureties with its construction risk for a given period based on the status of the projects for which the Surety has issued a bond. By monitoring the projects for which the Surety has issued a bond, the Status System is able to indicate the outstanding values of any potential claims against the Surety. It allows the Surety to get additional or more timely backing from reinsurers because the Surety can provide documented proof of its construction risks in a more accurate and much faster time period. In another embodiment, the Status System works in conjunction with a Loan Application Financing, wherein the payment of funds by the Lender is documented and or requested within the Pay Application portion of the Status System.

The steps in the methods and the computer code and/or processes in the system disclosed and claimed herein, as applicable to the method or system, can be performed by a single entity or multiple entities, single system or multiple systems, in the U.S. or abroad, individually or collectively, all of which are expressly within the scope of the claims and disclosure.

### BRIEF DESCRIPTION OF THE SEVERAL VIEWS OF THE DRAWINGS

FIG. 1 is a network diagram of interconnection between Surety, Principal, Obligee, and Surety Service Provider.

FIG. 2 is a flowchart representing one embodiment of the Status System invention.

FIG. 3 is a flowchart representing one embodiment of Pay Application aspect of the Status System.

FIG. 4 is a flowchart representing one embodiment of the Surety Link System aspect of the invention.

### DETAILED DESCRIPTION OF THE INVENTION

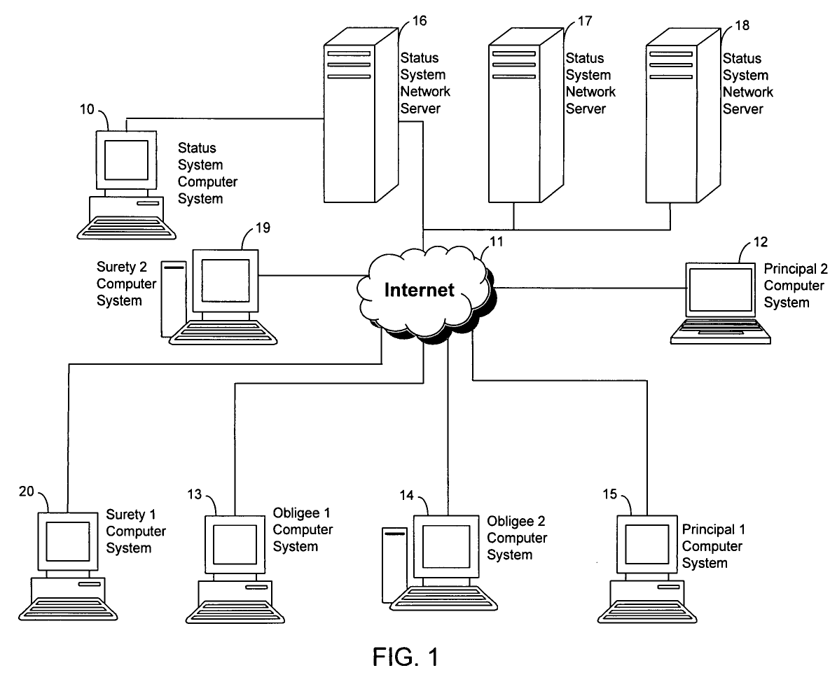

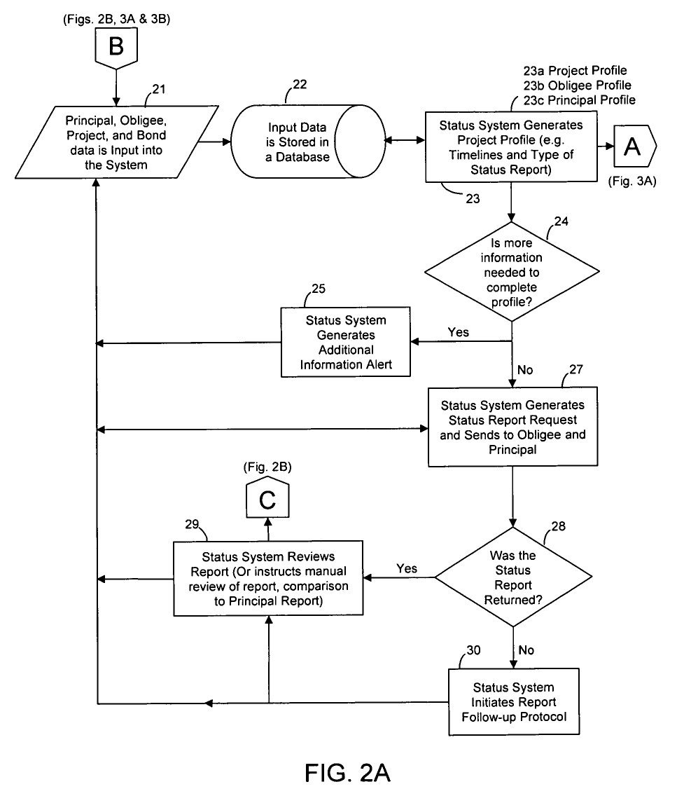

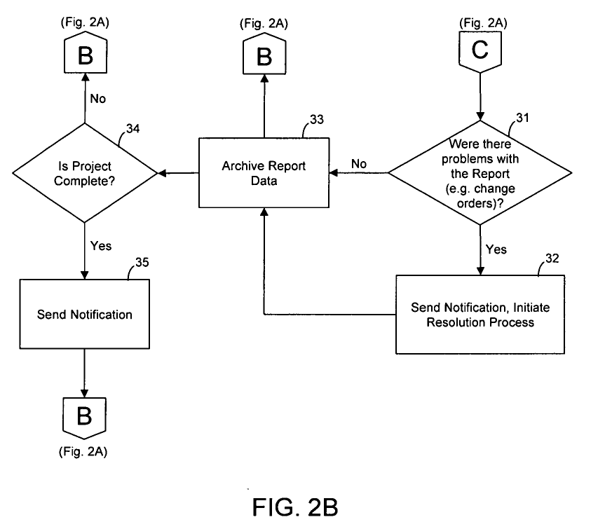

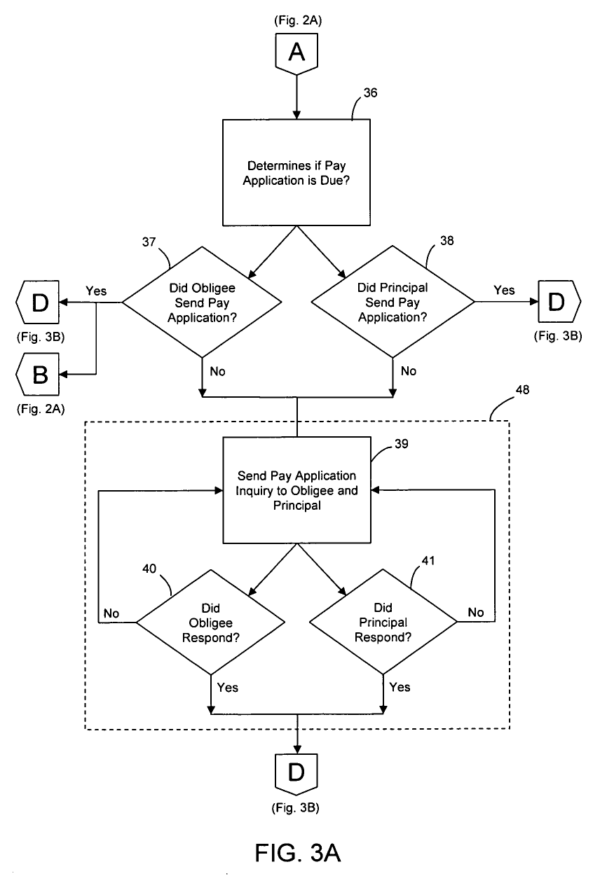

As shown in FIG. 1 the Surety, Status System Provider, Obligee and Principal can all use multiple computing devices 10, 12, 13, 14, 15, 19 and 20 to communicate via a network such as the Internet 11, local area networks, wide area networks, and intranets. The system can also include network servers 16, 17, and 18 that can store applications and databases used in the Status System. An embodiment of the invention is illustrated in FIG. 2 by way of a flow-chart.

FIG. 1 illustrates an example of a general configuration of a typical computer and network server arrangement that can be used to implement an embodiment of the Status System invention shown in FIG. 2. As shown in step 21, data from the Principal, Obligee, and Surety is input in the Status System. This data can include information such as the name, taxpayer identification number, address, phone number(s), electronic mail addresses, and name of the company representative for the Principal, Obligee and Surety. Additional information, such as a Principal's project history, an Obligee's claim history, or a Surety's history as it relates to various Principals and Obligees can also be included. It should also be understood that Sureties are typically required for projects in the public sector whereas Lenders, such as banks, may be used in place of the Surety for private construction contracts. Therefore, the use of Surety and Lender as it relates to the various embodiments of the invention can be used interchangeably. In a preferred embodiment, an agent acting on behalf of the Surety or on behalf of multiple Sureties maintains the Status System. However, other embodiments of the invention contemplate the Status System being maintained by the Surety, or being maintained and operated by a Status System Servicer.

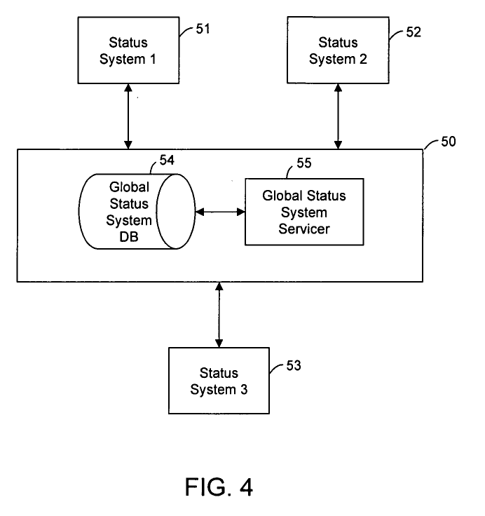

In one embodiment, both the Principal and Obligee have access to a database housed on the Surety's network. For example, the Principal and Obligee can access this database via the internet or via secure remote access using the Surety's intranet. In some instances, a portion or all of this information can be entered via manual operation, or the information can be automatically or semi-automatically transferred via queries to Surety bond databases, such as the Global Status System database 54 of the Surety Link System 50 shown in FIG. 4 and as described in more detail below. The Surety Link System 50 links or provides access to multiple Surety, Obligee and Principal data that is housed or generated across multiple Status Systems. Preferably, the Obligee and Principal have a web-based Application that has a user interface with the Status System. Additionally, the Status System can be web-based via a secure connection and can allow remote access to the password protected proprietary system. In other embodiments, applets running on individual computer systems or servers of the Obligees and Principals communicate and transfer data with the Status System via an interface. An important piece of data is the project data for the project on which a Surety bond has been issued. An example of project data is a description of the project, the type of industry that the project serves, the cost of the project, the estimated completion date of the project, the Obligee(s) and Principal(s) involved in the project, the payment structure and schedule for the project, and a timeline with specific milestones for the project.

All of the data, as represented by step 21, is stored in database 22. Although FIG. 2 may illustrate only a single database 22, database 22 can include several databases 22 that can be both internal and external to the Status System, and that are designed to communicate with the Status System. The databases 22 can be housed in a single server 16 or across multiple servers 16, 17, 18 in multiple locations, as illustrated in FIG. 1. Additionally, these databases 22 can be directed to an individual project, an individual Obligee, an individual Principal, the reinsurer, the Surety, or a combination of these entities.

When an Obligee or Principal's information is initially entered or populated into the Status System, the system creates an Obligee Profile 23b and Principal Profile 23c. Based on the information stored in the database 22, the Status System generates a Project Profile 23a. The Project Profile 23a can include an automatic timeline to generate Status Requests 27 to both the Obligee and the Principal on a periodic basis. In a preferred embodiment, the Status System is a real-time system that is periodically or continuously updated with data from a project, the Obligee, the Principal, and the Surety. As will be explained more fully below, because data the Status System is periodically updated, the Project Profile 23a, Obligee Profile 23b, and Principal Profile 23c can routinely change.

At step 24, the Status System then determines if it has enough information to complete a Profile 23. If information is missing, the Status System generates an Additional Information Alert 25. For example, the Additional Information Alert 25 can include an electronic request to the Obligee or Principal for more information about the Obligee's or Principal's data, or clarification of data that may be inconsistent with other data accessible by the Status System. The electronic request can be in the form of electronic mail or a text message to a mobile communications device, such as a cellular phone or PDA. The electronic request can also include a link that provides the recipient of the electronic request with access to a web server or intranet of the Status System host, wherein the Obligee or Principal can directly input the missing information into a database. In another embodiment, the Obligee or Principal have an application software or applet that has a user interface with the Status System or database 22. For example, an electronic mail can include a link that opens up the Status System interface application running on the individual computer or network of the Obligee or Principal, wherein the Obligee or Principal can enter the required missing information. The electronic communications described throughout this specification can be associated with a specific project, an Obligee, a Principal, etc., and can include unique identifiers, such as “Project ID” that automatically associates the electronic communication with a project. In another aspect, the electronic request includes an executable file that updates when executed by the Obligee or Principal automatically updates the Obligee or Principal's application program and prompts the user to update the required information. In another embodiment, the Status System will send via facsimile, postal or other non-electronic mail delivery methods a paper request for more information. The occurrence of the Additional Information Alert 25, the method of delivery to the Obligee or Principal, as well as the response from the Obligee or Principal, can be stored in a database 22.

If the Status System determines that it has enough information to complete a Profile 23, the Status System generates a Status Request 27. The Status Request 27 can be in the form of a status report that is sent to the Obligee. The Status Request 27 can also be in the form a status report that is sent to the Principal. In one embodiment, the Status System sends the Status Request 27 to both the Principal and Obligee. Like the Additional Information Alert 25 described above, the Status Request 27 can be sent to an Obligee or Principal via several electronic and non-electronic methods and the method of inputting data into or updating a status report can also be performed the methods described above for the Additional Information Alert 25. For example, in a preferred embodiment the Obligee provides an email address that is input as part of the Obligee contact data. The Status System uses this email address to send the Status Request 27 the Obligee. The email can include a link or an html address that directs the Obligee to a web-based server or an intranet of a Status System user, wherein the Obligee can input information directly into a form, questionnaire or the like that provides a status report on the project in response to the Status Request 27. In another embodiment, the email includes a Status Request 27 in the form of a word processing file (e.g. MSWord, WordPerfect) or PDF (fillable or non-fillable). Still other embodiments include sending the Status Request 27 via facsimile and non-electronic methods (e.g. U.S. Postal First Class Mail). In a further aspect of these embodiments, the Status System receives confirmation that the Status Request 27 has been delivered to the Obligee or Principal, this can be in the form of an electronic delivery/receipt confirmation within electronic mail or text messaging, but can also include delivery confirmation via the U.S. Postal, Federal Express, United Parcel System, or DHL systems delivery confirmation system.

In a preferred embodiment, as a part of the process of creating a Project Profile 23a, based on the Project, the Obligee, the Principal, or the Surety data 22, the Status System generates a report, milestone, and frequency of update based on the type of project covered by a Surety bond. The Status Request 27 can also be based on the length of the project. For example, if the project is a real-estate development project to build a high-rise condominium and the estimated duration is 26 months, the Status System might generate a Status Request 27 once a month. In connection with generating the Status Request 27 at monthly intervals, the Status System will also generate a deadline for response by the Obligee or Principal at some period (e.g. 10 days after the Status Request 27 is sent to or received by the Obligee or Principal). In a further aspect, as the expiration of the reply period approaches (e.g. within 5 days of the response due date) the Status System sends reminders (e.g. once daily) that a project status update is required.

The Status System then determines if the Status Request 27 report has been timely returned at step 28. If the Status Request 27 is not returned, the Status System initiates a Follow-Up Protocol 30 and provides the lack of response to the Status Request 27 to the database 22. Preferably, all data inputs, data requests, and responses received or generated in the Follow-Up Protocol 30 process are stored in some form in the database 22. The Follow-Up Protocol 30 preferably includes the Status System automatically sending a reminder via electronic communication to the Obligee or Principal. This reminder will preferably include a copy of the Status Request 27. The Follow-Up Protocol 30 can also include prompting an instruction that the Obligee or Principal be called. The occurrence of both the reminder and an instruction to call the Obligee or Principal is stored in database 22. In one embodiment, the Status System sends an email to a Status System employee that instructs the employee to call the Obligee or Principal and request that the Status Request 27 be returned. In this aspect, in an effort to document all transactions, in conjunction with the email sent to the Status System employee there is also a space or form, where the employee is prompted to input notes about the call (e.g. date and time of call, phone number called, name of person(s) the employee spoke with, substance of the call, status of the project, and anticipated return date of the Status Request 27). This input information is stored in a database 22. In a further embodiment, the employee updates the status report based on the information received from the Obligee or Principal.

If the employee is successful in contacting the Obligee or Principal, the Follow-Up Protocol 30 can also include setting an anticipated project status update receipt (e.g. 3 days after contacting the Obligee or Principal). In this aspect, if the Obligee or Principal does not timely return the status report, the Status System again prompts that a call or electronic communication be sent to the Obligee or Principal as described above. The Status System's database 22 recording of non-responsiveness from the Obligee or Principal (e.g. refusal of an Obligee or Principal to respond to a Status Request 27) provides valuable information as to the character or insurance or bond risk associated with an Obligee or Principal, or the possible waiver of a claim by the Obligee. Additionally, as described in more detail below in reference to the Surety Link System 50 aspect and shown in FIG. 4 (described below), this non-responsiveness information provides a basis for determining the rate at which a bond should be issued based on the history of the Obligee or Principal. Once the Status Request 27 report has been returned, the Status System reviews the report at step 29.

If the Status Request 27 is returned, the Status System initiates a Review Report Protocol 29. In a preferred embodiment, the status report is received electronically in a form that is easily read and the data automatically input into a database 22. The receipt and content of the status report is stored in the database 22. In another embodiment, the status report is stored in an electronic file (e.g. a PDF file) on the Status System server. The status report form can include questions that require the user to provide a yes or no answer, such as:
Is the project on schedule?
Is the project complete?
Have there been any change orders?
Has the scope of the project changed?
Has the work progressed satisfactorily?
Are you aware of any unpaid bills for labor?
Are you aware of any unpaid bills for or material?
Are you aware of any stop notices?
Are you aware of any mechanics liens?
   The Status System can also use Intelligent Recognition and Artificial Intelligence software in order to identify potential problematic reports. For example, using Artificial Intelligence software, the Status System may determine that based the use of individual, multiple, or a string of words, including a phrase, there is a potential problem with the report. The Status System determines if there are problems with the report at step 31. Based on the answers to these questions, this can signal a potential problem with the project that may affect the liabilities of the Surety, or can signal that the Surety is due a premium. For example, if the Obligee indicates answers “yes” to the question “have there been any change orders,” this can signal that the Surety is due a premium based on the change order. An example of another question that may signal a problem is, “what percentage complete is the project.” If this same question is posed to the Principal in a Status Request 27, and the Principal's response is 60% but the Obligee's response is 20%, this can signal a potential problem that needs further investigation. Another potential problem the Status System helps to identify is whether a project is running behind schedule. If the Status System expects to receive a response that the project is complete, but receives a project incomplete from either the Principal or the Obligee, this can signal a potential problem. If there are potential problems with the report, a notification is sent to the Surety, and the Resolution Process 32 is initiated. The report is also archived at step 33 and the report data is stored in database 22.

In some instances the review of the report will be a manual process. For example, if there is a potential problem alert as described above based on the electronic review by the Status System or answers to certain trigger questions as described above, as a part of the Resolution Process 32 manual review of the status report can be triggered. In other embodiments, the Status System may request or trigger the manual review of every status report or manual review of reports from certain Obligees or Principals. The triggers can be based on information in the database 22 or within a super network database, such as the Global Status System Database 54 provided via the Surety Link System 50 aspect and shown in FIG. 4 (described below) that links or provides access to multiple Sureties, Obligee and Principal data. For example, a Status System Servicer that services multiples Sureties, and therefore has data compiled for multiple projects, Obligees and Principals, may have negative information on an Obligee or Principal. In this aspect, the Status System determines that there should be a manual review of the status report for an Obligee or Principal based on negative information on an unrelated or related project. The manual review trigger could also be based on historical data on the Obligee or Principal, such as data from the Surety Link System 50 that there are routine problems associated with an Obligee or Principal. Other examples include manual review triggers if the Obligee or Principal has flags associated with their identity. These flags can be based on problems an Obligee is having with a different Principal on a different project.

In a further aspect of this embodiment, those Status Request 27 reports that are received via facsimile or non-electronic delivery means, such as via U.S. Postal mail, will require manual review. In another aspect, all status reports received via facsimile or non-electronic delivery are scanned (including possible OCR) and electronically stored in a file or database location accessible by the Status System, thereby allowing electronic automatic review by the Status System.

The Resolution Process 32 can include a request to make a site inspection of the project and scheduling a meeting with the Principal, Obligee, and Surety. In one embodiment, the information entered that formed the Project Profile Data 23 determines the Resolution Process 32. For example, if the Surety has contracted with a Surety Service Provider to manage the oversight of a project's status (e.g. using the Status System), the Surety may have also indicated that when problems arise, such as potential change orders, or inconsistencies in percent completion of work, it would like the Surety Service Provider to perform this function. Preferably, this desire is a part of the information stored in the database 22 that forms a Project Profile 23a. In one aspect, the Resolution Process 32 automatically generates a task. These tasks can include, but are not limited to a project site inspection; interviews of the Principal, Obligee, or project owner; performance of a labor or material consumption analysis; a project audit that can include an estimated cost to complete; an audit of the Principal's Work in Progress Schedule; and a complete audit of the Principal (e.g. audit of the Principal's financial status and overview of the Principal's operation).

If there are no answers that appear to be problematic or inconsistent in the Obligee's or Principal's Status Request 27 report, the status report data is archived at step 33 and ultimately stored in the database 22. At step 34, the Status System determines if the project is complete based on the response to the status reports. If the project is complete, the Status System sends a notification 35 to the Surety and updates the database 22. If the project is not complete, the Status System updates the database 22 and at the prescribed period, the next Status Request 27 report is sent to the Obligee and Principal.

### Pay Applications

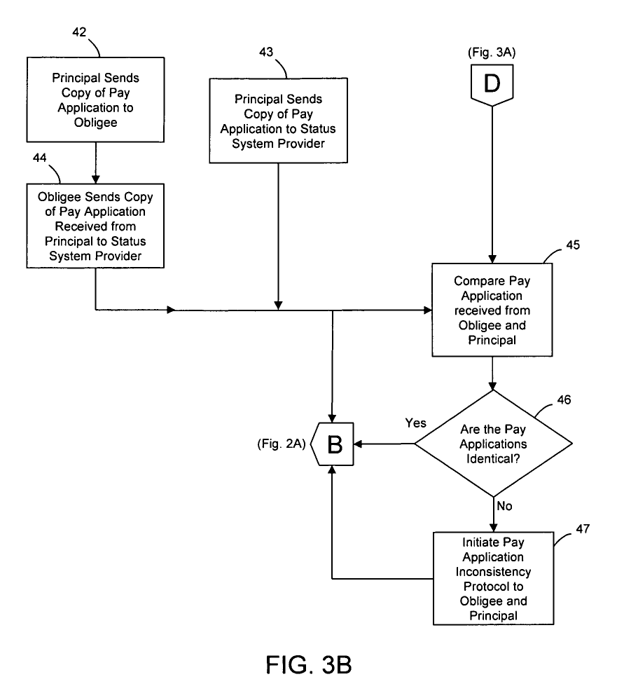

In another embodiment, the Status System monitors the status of a project and anticipates potential problems using pay application data. The Pay Application Protocol of one embodiment of the invention is shown in FIG. 3. In a preferred embodiment, the Status System creates a pay application schedule or timeline based on an anticipated timing for a “pay application” for a particular project as a part of the generation of the Project Profile 23a as shown in FIG. 2. In one embodiment, the Status System determines if a pay application is due at step 36 and queries the database 22 to determine if the Obligee and Principal have sent pay applications at steps 37 and 38. If the Obligee and Principal have sent in pay applications, the Pay Application Protocol at step 45 compares the pay applications as described in further detail below. If either the Obligee or the Principal have not filed a pay application, within the time determined by the Status System, the Status System initiates a Pay Application Inquiry Protocol 39 to either or both the Obligee and Principal.

The Pay Application Inquiry Protocol 39 preferably includes the Status System automatically sending a pay application inquiry to the Obligee or Principal via electronic communication. The method of delivery and of updating or responding to the pay application inquiry can be identical to those methods described above for the status reports. As with other embodiments of the invention, the occurrence of the pay application inquiry is stored in the database, and the pay application inquiry (e.g. email, text message) is stored in an electronic file. The Status System preferably uses the email address found in the profile data of the Obligee and Surety to send the pay application inquiry to the Obligee or Principal. The email can include a link or an html address that directs the Obligee or Principal to a web-based server or an intranet of a Status System user, wherein the Principal or Obligee can input information directly into a form, questionnaire or the like that provides detail on whether any pay applications have been received, whether any payments have been made, and the status of the project. The pay application inquiry may also include inquiries as to when the Obligee expects to receive a pay application and when the Principal expects to issue a pay application. Additionally, information such as confirmation of electronic or non-electronic delivery of the pay application inquiry is also stored in the database, in a similar operation as described above in reference to the status report.

The Status System determines when a response to the pay application inquiry should be received (e.g. 5 days after the pay application inquiry is sent to or received by the Obligee or Principal). The Status System then determines if the Obligee or Principal has timely returned the response to the pay application inquiry at steps 40 and 41. If the pay application inquiry response is not timely returned, the Status System initiates a Pay Application Follow-Up Protocol 48. Preferably, all data inputs, data requests, and responses received or generated in the Pay Application Follow-Up Protocol 48 process are stored in some form in the database 22 or in another electronic file. The Pay Application Follow-Up Protocol 48 can includes the Status System automatically repeated inquires via electronic communication to the Obligee or Principal. Preferably, the Pay Application Inquiry Protocol 39 includes prompting an instruction that the Obligee or Principal be called. The occurrence of both the reminder and an instruction to call the Obligee or Principal is stored in database 22.

In one embodiment, the Status System sends an email to a Status System employee that instructs the employee to call the Obligee and inquire about pay applications. In this aspect, in an effort to document all transactions, in conjunction with the email sent to the Status System employee there is also a space or form, where the employee is prompted to input notes about the call (e.g. date and time of call, phone number called, name of person(s) the employee spoke with, substance of the call, status of the project, information about pay applications and payments made by the Obligee, and anticipated receipt of any pay applications). This input information is stored in a database 22. Preferably, all data inputs, data requests, files, and responses received or generated in the Pay Application Inquiry Protocol 39 process are stored in some form in the database 22 or another electronic file. Once the Status System determines that both the Obligee and Principal have sent in pay applications, the Pay Application Protocol at step 45 compares the pay applications as described in further detail below.

It should be understood that because the preferred embodiment includes the Status System database 22 being continuously updated with information, ideally, because the Obligee and Principal would automatically upload the pay application, or pay application data, or send in electronically or via non-electronic means the pay applications, there would be no need for the Status System to initiate the Pay Application Inquiry Protocol 39. Also, in those aspects of an embodiment of the invention that involve the Status System determining when a pay application is potentially due; the Status System would automatically determine that the pay application potential due date has been fulfilled because the database would have been updated to show receipt of the pay applications.

In a preferred embodiment, the status reports can include a question such as “has [Principal A] submitted a pay application.” In a further aspect, if the Obligee or Principal answers yes, the status report prompts the user to attach an electronic copy (i.e. a PDF) of the pay application. Preferably, the Obligee and Principal submit pay applications electronically via web-based internet access to the Status System. As shown in FIG. 3, the Principal submits its pay application to the Obligee at step 42 and to the Status System service provider at step 43. The Obligee then submits the pay application to the Status System service provider at step 44. The Status System compares the pay applications at step 45. In the preferred embodiment, the comparison of the pay applications is performed electronically via the Status System software. This comparison can use the Intelligent Recognition and Artificial Intelligence software as described above. As described above in reference to the status reports, triggers within the Status System can initiate the manual comparison of the pay applications. In a further aspect of this embodiment, those pay applications that are received via facsimile or non-electronic delivery means, such as via U.S. Postal mail, will require manual review. In another aspect, all status reports received via facsimile or non-electronic delivery are scanned (including possible OCR) and electronically stored in a file or database location accessible by the Status System, thereby allowing electronic automatic review by the Status System.

Ideally, the pay applications should be identical. However, in some instances where there is a potentially dishonest Principal or Obligee the pay applications are different. For example, the Principal may attempt to collect proceeds that exceed the estimated payable-to-date amount in view of the percentage of project completion. In this instance, this signals that there maybe incorrect data being tracked in the Status System and that there is a potential problem with the project or Principal. This may also signal that there are potential change orders that have not been reflected within the Status System, thereby bypassing the payment from the Principal to the Surety of any additional premium.

If the pay applications are identical, at step 46 the Status System database 22 is updated with this information. Although FIG. 3 may show only certain information from the Pay Application Protocol being updated to the database 22, in a preferred embodiment, all data inputs, data requests, and responses received or generated in the Payment Application Protocol process are stored in some form in the database 22. For instance, as shown in FIG. 3, the receipt of the pay application from the Obligee at steps 37 and 44, and the Principal at step 43 is updated in the database 22, and provides the Status System Servicer with electronic access to a copy of the pay applications stored in an electronic file accessible via the Status System or data from the pay applications.

If the pay applications are inconsistent, the Status System initiates the Pay Application Inconsistency Protocol 47. In this aspect, the Pay Application Inconsistency Protocol 47 of the Status System sends an inquiry via an electronic communication to the Obligee and Principal requesting additional information on the inconsistent pay application, such as verification of the pay applications, and a request for copies of payments made by the Obligee to the Principal. In another aspect, the Status System generates an alert that is sent to an employee of the Status System Servicer. The alert instructs the employee to contact the Obligee and Principal to verify the pay application input data, and if applicable, request copies of any pay applications that are not within the Status System, and request copies of any payments made by the Obligee to the Principal. As with the Status Report, the employee is prompted to input all communications and data into the Status System, which is ultimately updated in database 22.

All alerts generated by the Status System, including the Pay Application Protocol, are sent to the Surety or Surety agent when a Status System Servicer is operating the Status System. If the inconsistency in the pay applications was resolved as a simple mistake, no negative mark or point is placed in the Status System database 22. However, if the resolution of the inconsistency resulted in a determination that there was attempted fraud, dishonesty, or premium avoidance, a negative mark or point is added to the responsible parties. In another aspect, the negative point is not only attributable to the culpable party, but for pattern determinations, the link between the specific entities or parties is also stored within database 22. For example, in the “clearing house” aspect of an embodiment of this invention, when a Principal applies for a bond with a Surety, if the Surety has access to the Surety Link System (“SLS”) 50 as shown in FIG. 4 and described in more detail below, the SLS 50 will search the Global Status System Database 54 for a history of the Principal. Likewise, the SLS 50 has the capability of searching the Global Status System Database 54 for a history of a particular Obligee or other interested party. Further, the SLS 50 using search engine tools such as BRS and APS capable of operating using Boolean or other logic search tools has the capability of searching for combinations of Principals, Obligees, interested parties, to see if there are any negative points or reflections for a combination of entities. Any points or negative reflections are available to the Surety, and allow the Surety to make a more informed decision before issuing the bond. The SLS 50 also provides the Surety with the ability to charge a higher premium—or in the case of a pattern of positive information, a lower premium—for the bond. As in other embodiments of the invention, in a preferred embodiment, all data inputs, data requests, and responses received or generated in the Pay Application Inconsistency Protocol 47 process are stored in some form in the database 22.

In one embodiment, the Principals are required to use the Status System local Application program to submit pay applications, or using the web-based interactive Status System, wherein the Principal can construct and submit the pay application via the Status System. In another embodiment, in order to ease the organization, filtering, of data in the Status System's database 22, the Surety or the Status System Servicer acting on behalf of the Surety provides the Principal with a standard pay application form to be used by the Principal for all jobs being tracked using the Status System. In this embodiment, the form has dedicated data input fields that are easily loaded and compiled in the database 22. This same form is submitted by the Obligee and allows the Status System to easily compare the forms based on the dedicated data input fields in order to determine if the forms are identical.

In order to be paid for the work performed, the Principal submits a Pay Application to the Obligee for payment. The Obligee or the Obligee's Representative who will either approve or reject the pay application evaluates the Pay Application. Using the Status System, the approval or rejection is noted in the database 22. If the Pay Application is rejected, it will be returned to the Principal to correct any deficiencies, which preferably updated in the database 22 by both the Principal and the Obligee. If the Pay Application is approved, it is then submitted to the Lender for evaluation and payment as described in the co-pending application Ser. No. 11/295,738, U.S. Publication No. 20070130064 entitled “Construction Loan Process System and Method” (“the '064 Publication”), which is hereby incorporated by reference in its entirety. In another embodiment, the Lender or Bank is in communication with an aspect of the Status System, as has the capability of electronically communication the acceptance, rejection, and payment of a Pay Application, and provides data updates on the payment from the Lender to the Status System database 22.

In another embodiment, via the web-based interactive Status System program, via electronic mail communication, or via the execution of a Status System applet or application software housed on the Obligee or Principal's computer or computer network, the Obligee or Principal provide payment information to the Status System Servicer as payments are made to or received by the Principal. In a preferred embodiment, the status report as described in FIG. 2 includes a question that asks have there been any payments made by the Obligee to the Principal. Similar to the pay application, if the Obligee or Principal answers “yes” to this question, the Status System prompts the user to attach an electronic copy (e.g. a PDF) of the payment (not shown). Preferably, the Obligee and Principal submit copies of the payment electronically via web-based internet access to the Status System. As with other aspects of some embodiments of the invention, the Status System database 22 is updated with this payment information and the file is saved electronically. The Status System then compares the payment data to other data within the system, such as the dollar amount of the pay application for which this payment is or should be associated with, and the project's actual or anticipated percentage completion.

### Loan Application Financing

In one embodiment, in conjunction with the Status System creating a Project Profile 23a, the Schedule of Values as described in the co-pending '064 Publication is included as a part of the information input, stored, pulled, or loaded into database 22. For example, at the beginning of each project the Principal, Obligee, Surety, and Construction lender, negotiate a mutually acceptable Schedule of Values. The Schedule of Values presents a detailed breakdown of work activities and their respective monetary value. Utilizing this schedule, project payments will be made. In addition to comparing the pay applications, as described above, because the Status System has the Schedule of Values stored in its database 22, the Status System also compares the pay application with the Schedule of Values in order to determine if the pay applications are consistent with the Schedule of Values at a given point in time. In another embodiment, the payments actually made by the Obligee to the Principal are also compared to the Schedule of Values in order to determine if the payments are consistent with the Schedule of Values at a given point in time. In another aspect of the embodiment, the Harmony Construction Loan Process as described in the '064 Publication is incorporated into and used in conjunction with the Status System. For example, during the Funds Control Administrator of the '064 Publication is in communication with the Status System and receives and provides information about the Pay Application.

### Surety Link System

Another embodiment of the invention is illustrated in FIG. 4 and has been briefly discussed previously in the specification, as shown, multiple Status System Primary Applications 51, 52, and 53 are being run by multiple Sureties or Status System Servicers. Each of the Status Systems 51, 52, 53 are in communication with the Surety Link System (“SLS”) 50. The Surety Link System 50 includes a Global Status System 55 and a Global Status System Database 54. The SLS 50 provides a communication link among Sureties and Status System Servicers, wherein the Sureties or Status System Servicers using the Status System Primary Applications 51, 52, 53 can receive historical and current information about Obligees and Principals via the Global Status System Database 54.

The SLS 50 acts like a clearinghouse or screening system for Sureties, so that they can obtain historical performance information on Principals and Obligees. This information can include claims made by Obligees for performance on a Surety bond, claims filed against Principals on a Surety bond, litigation claims, alerts of complaints, problems, attempted fraud, or overruns by Principals or Obligees on previous projects. In a preferred embodiment, the SLS 50 is operated and maintained by a Surety System Servicer, and the Status System Primary Applications 51, 52, and 53 represent Status System applications for a variety of Sureties. It should be understood that the Surety System Servicer could be a Surety Agent that acts as a Surety Agent for multiple Sureties. In this embodiment, the Surety System Servicer receives data from the databases 22 within the Status System Primary Applications 51, 52, and 53 on a variety of Obligees, Principals, and Sureties. Based on the information, such as project overruns, project delays, Principal defaults, claims against a Principal, missed deadlines or milestones, and change orders, it allows the Surety System Servicer to foresee these same potential problems for the current project with Obligees and Principals, or projects, based on the compiled data. It also provides the Surety System Servicer with the ability to determine if a particular Obligee or Principal is purposefully avoiding the updating of a status report, or pay application. For example, in those projects having common Principals and Obligees, it allows Surety to determine if there is a potential problem when the Obligee does not respond to a status report request or pay application inquiry for one project, yet responds to those requests on another project.

Because multiple project data is accessible via the SLS 50, the SLS 50 also provides an opportunity for the Surety to determine if there is a potential for or funds are being misdirected by the Principal, for purposes outside the subject project such as working capital to start other projects, or to cover costs or losses on other projects, or to cover Costs in Excess of Billings (as described in the '064 Publication and incorporated by reference herein) on other projects.

Although the SLS 50 as shown in FIG. 4 shows the SLS 50 being in communication with Status System Primary Applications 51, 52, and 53, it also an embodiment of this invention that the SLS 50 can act as a clearing house, or “project performance background” check for Principals and Obligees for Sureties not using the Status System. For example, it can be used to provide background performance data for a Surety that has received a bond application from the Principal. The Surety could make an inquiry to the SLS 50 seeking information on a particular Principal or Obligee. Preferably, the request will be via electronic information, but it can also include telephone inquiries, facsimiles, and non-electronic communications methods. The SLS 50 also has the capability of linking the items within its Global Status System database 54 based on common identifiers such as common emails, common responsible party, common contact info (phone number, address, etc.), and common taxpayer ID numbers. The SLS 50 can compile the various data on the performance of Obligees, Principals, Interested parties (investors).

In another aspect, the SLS 50 provides a tool to rank the risk associated with the use of Obligees, Principals, Interested parties (investors), or a combination thereof. The SLS 50 can provide data on previous problem associated with the use of an individual Principal or Obligee, and it can provide problems associated with the combination of specific Principals and Obligees. The SLS 50 can sell this information to Sureties and Surety agents that use the Status System Primary Applications 51, 52, and 53, and those Sureties and Surety agents that do not use the Status System.

It should be understood that a project could have many Principals that are covered by a variety of Surety bonds, which may or may not be issued by the same Surety. For example, there is typically a prime contractor and a variety of sub-contractors. In this aspect, using the SLS 50 provides Sureties, Surety Agents, and Status System Service Providers with the ability to identify potential problems or patterns based on alerts or flags associated with multiple Principals or a combination of multiple Principals.

In another embodiment, notifications of alerts are automatically sent to the Surety, via electronic communications, facsimiles, or non-electronic communication methods. Preferably, the Surety provides information on the type of alerts it wishes to receive, such as unreturned status report, change order, potential premium due the Surety, and the project is behind schedule.

Although, the reference has been primarily to Sureties, it should be understood this information could also be provided to the Surety agent. Additionally, it should also be understood that a Status System Servicer could operate the SLS 50. For example, individual Sureties, Surety Agents, or a combination of Sureties, Surety Agents, and Status System Sub-Servicers can operate the Status System Primary Applications 51, 52, 52.

### Sureties Construction Risk Period

In another embodiment of the invention, the Status System provides details of a Surety's outstanding bonds and allows the Surety and its reinsurers to know in real-time fashion the construction risk for a given Surety. In this aspect, it allows the Surety and reinsurer to know the aggregated risk exposure of the Surety. Because the Status System provides detailed analysis of construction status, project's percentage completion, pay applications, and potential claims, Sureties are able to get more underwriting in a timely fashion. The Status System can also provide details of a Surety's outstanding bonds to a variety of entities and organizations, such as the Small Business Administration (“SBA”) and bond rating agencies.

### Legal Ramifications

In another embodiment, the Status System includes alerts that trigger when an Obligee may have waived a potential claim against the Surety Bond. In the preferred embodiment, the Status System Project Profile 23a includes the provisions of the bond and ties those provisions to certain actions or alerts within the Status System. In one aspect, the bond may provide that the failure to return a status report within 30 days of receipt of the status report, results in a waiver of any claims for a period of more than 45 days before the status report update was due. The Status System has this information stored in the database 22, and as a part of the periodic updates of the Status System, if an Obligee has failed to return or update a status report for over 30 days, at the 31^{st} day, the Status System automatically generates an alert, and project profile notation, that the Obligee has possibly waived any claims that occurred later than 45 days before the status report was due. In this embodiment, this alert will not only be updated in the systems database 22, but will also be communicated to the Surety or Surety Agent. In another aspect of this embodiment, other provisions of a bond or an application of local, State or Federal Act and provisions (e.g. the Miller Act, public works or municipality provisions) that may apply to a bond are also input or housed within the Status System and tied to specific acts or omissions by the Obligee or other interested parties, in order to generate alerts, and database updates.

The foregoing disclosure and description of various embodiments of the invention are illustrative and explanatory thereof, and various changes in the details of the illustrated apparatus and construction and the method of operation may be made without departing from the spirit of the invention.

What is claimed is:

1. A system for monitoring the status of a work project, the work project being performed for an Obligee, a Principal having the responsibility to perform the work project, and a Surety having the financial responsibility for guaranteeing to the Obligee the Principal's performance of the work project, the system comprising:
a communications network that allows the Obligee and Surety to communicate;
a computing device in communication with the communications network, the computing device configured to receive input data, wherein at least a portion of the input data describes the work project; and
computer code that when executed by the computing device:
generates an Obligee request for a work project update, wherein the request for the work project update is communicated to the Obligee;
generates expected results and an expected completion-time value for the Obligee work project update;
determines if the Obligee work project update has been timely completed;
initiates a request for a work project update follow-up routine if the Obligee work project update has not been completed;
compares a completed Obligee work project update to the expected results for the Obligee work project update if the Obligee work project update has been completed; and
generates a first alert if the Obligee work project update comparison results are unacceptable.

2. The system for monitoring the status of a work project of claim 1, further comprising computer code that generates resolution process tasks means for resolving problems with the Obligee work project update comparison results that are unacceptable.

3. The system for monitoring the status of the work project of claim 1, further comprising computer code that anticipates the time-period for when a pay application should be submitted and generates a second alert if the pay application has not been timely submitted.

4. The system for monitoring the status of the work project of claim 1, further comprising computer code that when executed by the computing device:
generates an anticipated pay application amount; and
generates a third alert if an actual pay application actual amount is inconsistent with the anticipated pay application amount.

5. The system for monitoring the status of the work project of claim 1, further comprising data collection wherein the input data, data on the work project, data on the Obligee work project update, Obligee work project update follow-up routine data, data on the expected results for the Obligee work project update, and Obligee work project update comparison results data are stored in a database.

6. The system for monitoring the status of the work project of claim 1, further comprising computer code that when executed by the computing device generates a seventh alert when there is a potential waiver of an Obligee's claim against a Surety bond based on the Obligees failure to timely respond to the Obligee request for a work project update.

7. The system for monitoring the status of the work project of claim 1, further comprising computer code that:
generates a work project profile based on at least a portion of the input data; and
generates the Obligee request for a work project update based on the project profile.

8. The system for monitoring the status of the work project of claim 1, wherein the first alert includes a change order by the Obligee.

9. The system for monitoring the status of the work project of claim 8, further comprising computer code that when executed by the computing device calculates a premium due the Surety based on the change order.

10. The system for monitoring the status of the work project of claim 8, further comprising computer code that when executed by the computing device calculates an increased liability for the Surety based on the change order.

11. The system for monitoring the status of the work project of claim 1, further comprising:
allowing the Principal and Surety to communicate via the communications network; and
computer code that when executed by the computing device:
generates a Principal request for a work project update that is communicated to the Principal,
compares the completed Obligee work project update to a completed Principal work project update when a Principal work project update is received; and
generates a fourth alert if the comparison result is unacceptable.

12. The system for monitoring the status of the work project of claim 11, further comprising computer code that when executed by the computing device:
compares an Obligee pay application to a Principal pay application; and
generates a fifth alert if there are discrepancies between the Obligee and Principal pay applications.

13. The system for monitoring the status of the work project of claim 12, wherein in the system is global monitoring system that monitors the status of multiple work projects that are performed by multiple Principals for multiple Obligees.

14. The system for monitoring the status of the work project of claim 13, further comprising data collection of the request for work project update follow-up routine, the completed Obligee work project update, the completed Principal work project update, the first alert, the fourth alert, and the fifth alert, wherein the data collection is stored in a database and the data collection is capable of being accessed to provide performance information on an Obligee, Principal and Surety.

15. The system for monitoring the status of the work project of claim 14, wherein the performance information includes a risk exposure for a Surety.

16. A system for monitoring the status of a work project, the work project being performed for an Obligee, a Principal having the responsibility to perform the work project, and a Surety having the financial responsibility for guaranteeing to the Obligee the Principal's performance of the work project, the system comprising:
a communications network that allows the Surety and the Principal to communicate;
a computing device in communication with the communications network, the computing device configured to receive input data, wherein at least a portion of the input data describes the work project; and
computer code that when executed by the computing device:
generates a Principal request for a work project update, wherein the request for the work project update is communicated to the Principal;
generates expected results and an expected completion-time value for the Principal work project update;
determines if the Principal work project update has been timely completed;
initiates a request for a work project update follow-up routine if the Principal work project update has not been completed;
compares a completed Principal work project update to the expected results for the Principal work project update if the Principal work project update has been completed; and
generates a sixth alert if the Principal work project update comparison results are unacceptable.

17. The system for monitoring the status of the work project of claim 16, further comprising computer code that when executed by the computing device:
anticipates the time-period for when a pay application should be submitted, and;
generates a second alert if the pay application has not been timely submitted.

18. The system for monitoring the status of the work project of claim 16, further comprising computer code that when executed by the computing device:
generates an anticipated pay application amount, and;
generates a third alert if an actual pay application actual amount is inconsistent with the anticipated pay application amount.

19. The system for monitoring the status of the work project of claim 16, further comprising computer code that when executed by the computing device:
generates a work project profile based on at least a portion of the input data; and
generates the Principal request for a work project update based on the project profile.

20. A method for monitoring the status of a work project, the work project being performed for an Obligee, a principal having the responsibility to perform the work project, and a Surety having the financial responsibility for guaranteeing to the Obligee the principal's performance of the work project, the method comprising:
communicating via a communications network, the communications network allowing the Surety and the Obligee to communicate via the communications network;
inputting data into a computing device, at least a portion of the data describing the work project, the computing device being in communication with the communications network;
generating a work project status inquiry;
generating an expected results and an expected completion-time value for the work project status inquiry;
communicating the work project status inquiry to the Obligee via the communications network, wherein the Obligee is expected to provide a timely response to the status inquiry;
monitoring the response status to the work project status inquiry; and
generating an alert based on the status of the status inquiry, wherein the alert is communicated to the Surety.
